(19) United States
(12) Patent Application Publication
(10) Pub. No.: US 2010/0218675 A1
(43) Pub. Date: Sep. 2, 2010

(54) GAS SEPARATION APPARATUS

(76) Inventors: Andre Buijs, Amsterdam (NL); Gerrit Jan Harmsen, Amsterdam (NL)

Correspondence Address: SHELL OIL COMPANY, P O BOX 2463, HOUSTON, TX, 772522463, US

(21) Appl. No.: 12/159,169

(22) PCT Filed: Dec. 21, 2006
(86) PCT No.: PCT/EP2006/070051

§ 371 Date: Jun. 25, 2008

(30) Foreign Application Priority Data
Dec. 27, 2005 (EP) 05112984.9
Dec. 27, 2005 (EP) PCT/EP2005/057173

(51) Int. Cl. B01D 53/22; B01D 63/06; B01D 61/00

(52) U.S. Cl. 95/45; 96/4; 96/8; 96/10

(57) ABSTRACT

A gas separation apparatus comprising: a first chamber; a second chamber, separated from the first chamber by a porous partition; a first inlet for conveying a mixture of components to the first chamber; a first outlet for discharging the remainder of the mixture of components after at least part of the first component has been removed from the first chamber; a second inlet for conveying a sweeping component into the second chamber; a second outlet for discharging a mixture of sweeping component and diffused first component from the second chamber, and a pressure equilibrating device connecting and mediating between the first and the second chamber; and a separation process using the separation apparatus.

### FIELD OF THE INVENTION

This invention relates to a gas separation process and an apparatus suitable for the process.

### BACKGROUND OF THE INVENTION

In chemical industry a multitude of separation techniques are employed to separate two or more components in a gaseous mixture. Examples of such separation techniques are known in the art and can be found for instance in chapter 5.7 of “Process Design Principles” by W. Seider et al., published by John Wiley & Sons, inc. 1999. A process and apparatus for gas separation is disclosed in U.S. Pat. No. 1,496,757, which process comprises diffusing the gases through a porous diffusion partition, removing the diffused gas away from the partition by means of a sweeping material and removing the sweeping material from the diffused gas. The process is said to operate on the principle of repeated fractional diffusion, i.e. the mass transfer is controlled by frictional diffusion with a sweep gas component continuously added to one chamber and diffusing counter-currently through the porous partitioning layer.

Although the above apparatus and process allow separating gas mixtures, the effectiveness of the separation is strongly reduced if a pressure differential exists on either side of the partition due to non-selective mass transfer towards the lower pressure side.

It has now been found that the above-identified diffusion-based separation method and apparatus operate more effectively if the two fluid streams are maintained at essentially the same pressure, i.e. that there is essentially no pressure differential over the porous partition during the process. The subject invention therefore provides for a separation process and an apparatus suitable for this process.

### SUMMARY OF THE INVENTION

Accordingly, the present invention provides for a separation apparatus comprising:

a first chamber;

a second chamber, separated from the first chamber by a porous partition;

a first inlet for conveying a mixture of components to the first chamber;

a first outlet for discharging the remainder of the mixture of components after at least part of the first component has been removed from the first chamber;

a second inlet for conveying a sweeping component into the second chamber;

a second outlet for discharging a mixture of sweeping component and diffused first component from the second chamber; and

a pressure equilibrating device connecting and mediating between the first and the second chamber.

### DETAILED DESCRIPTION OF THE INVENTION

The subject invention makes use of a pressure equilibrating device connecting and mediating between the first and the second chamber. This device is capable of transmitting a pressure differential from one chamber to the opposite chamber, thereby avoiding the formation of a pressure differential between the two chambers. In the pressure equilibrating device, pressure surges are transmitted from one fluid stream to the other fluid stream, thereby effectively maintaining the pressure differential over the porous partition at a minimum level.

The separation apparatus comprising the pressure equilibrating device can be any apparatus known to the skilled person to be suitable for this purpose. For example separation units can be used such as the ones exemplified in U.S. Pat. No. 1,496,757.

Any device suitable as pressure equilibrating device may be employed, including passive systems that act solely due to the force induced by the fluid streams, as well as active systems that allow controlling pressure oscillations within fluids, such as for instance the elaborate and complex systems regulating the pressure and flow of two fluid streams in response to pressure and flow values measured downstream or upstream of a separation device. However, such systems may have a too long response time to a pressure surge, as well as the difficulty to measure low pressure differentials as threshold.

Preferably, therefore, the pressure equilibrating device according to the present invention comprises at least one self-directing pressure and flow regulating device. Such a pressure-responsive device or valve controls the pressure between the chambers by being actuated solely by pneumatic pressure derived from the fluids being regulated, hence controlling fluid flow between the inlet and the chamber, acting as a flow restrictor.

The valve connecting and mediating pressure and flow between the first and the second chamber may conveniently be any device that is suitable for this purpose, including but not limited to pneumatically actuated piston- and sleeve arrangements, flexible diaphragms and hydrodynamic systems such as for instance a U-shaped tube containing a liquid medium.

In order to reduce and increase the pressure in the first or second chamber, respectively, the equilibrating device or valve comprises a control volume, which can expand into either fluid stream. If in one chamber the pressure increases, fluid from the stream expands the control volume, which exerts pneumatic or hydrodynamic pressure and thus reduces the volume of the opposite chamber, thereby equilibrating the overall pressure differential. In operation, the balance of force between the two sides the pressure equilibrating device determines volume of the two chambers, and at a given flow, the pressure.

Advantageously, the pressure equilibrating device is part of a valve chamber in which the first and second chamber of the apparatus of the invention that are associated with the two outlet conduits are situated. More preferably, the first and second chamber comprise the pressure equilibrating device within the chambers, for instance by incorporation into the porous partition.

The sensitivity of the pressure equilibrating device is determined largely by the inertia and by the size of the control volume regulating fluid flow through the chambers. With a piston and sleeve assembly, there are a number of potential sources where accuracy and precision may be reduced. First, inertia can cause a resistance to movement of the structural element that is responsible for directing fluid into and out of the control volume sleeve. Secondly, hysteresis of the mechanical portions of a piston and sleeve device creates different operating points, depending on the direction of fluid approach. Thirdly, temperature effects on the piston within the sleeve can be responsible for variation of friction values, and hence lead to a difference in applied force. Finally, in order to achieve gas-tightness, the piston and the sleeve have to be constructed in such way that friction occurs during the movement of the piston, in turn leading to inertia and hence a pressure differential between the two chambers.

Similarly, although technically very simple, hydrodynamic pressure equilibrating devices have the disadvantage that the liquid present in the equilibrating means is in contact with the gas streams, and hence may vaporize or affect the process otherwise.

The pressure equilibrating device according to the subject invention therefore preferably employs one or more diaphragms, i.e. a compressible elastically deformable elastic thin wall. A diaphragm is a sheet of a semi-flexible material anchored at its periphery. It serves as a barrier between two chambers, moving up into one chamber or down into the other depending on differences in pressure. The diaphragm acts as a throttling element as the control volume is allowed to expand or retract, modulating pressure and flow through the flow path.

This diaphragm may be of any suitable form, such as an expandable and retractable sheet, sleeve or boot-like diaphragm comprising a control volume, positioned and seated within a valve body about the main flow path between the two fluid streams. Preferably, the diaphragm is situated as close a possible to the first and second chamber in order to avoid local pressure differentials to build up at the porous partition. The elastic diaphragm, which may advantageously comprise an elastomer, such as rubber or silicone, or flexible metal sheet, transmits the pressure prevailing in one chamber to opposite chamber in a simple way, by being movable in response to differential pressure across it. By the relative pressure difference between the two chambers, the diaphragm can be set into an oscillating motion, which correspondingly controls the pressure in each fluid stream, independently from the overall pressure applied. The dimensions and the material of the equilibrating means may be routinely chosen by a person skilled in the art according to the requirements of the separation. In counter-current or cross-current operation, or if a large porous partition is employed, two or more diaphragms may be placed at suitable locations.

In a preferred embodiment the porous partition is a porous partition suitable for a separation by frictional diffusion. By separation by frictional diffusion is understood separation of a mixture of gases by taking advantage of their different rates of diffusion. Porous partitions suitable for such purpose are described in more detail below.

The porous partition can be made of any porous material known to the skilled person to be suitable for use in a process where it is contacted with the reactants. The porous partition can be made of a porous material that assists in the separation of the components by for example adsorption or absorption effects, provided that the separation by diffusion prevails.

The present apparatus and process differs from the frequently applied membrane separation by gas permeation through a selective membrane, in which process a large pressure differential is maintained on both sides of the membrane to force a permeate to pass through the membrane, leaving the retentate at the opposite side of the membrane, in that no selective membrane and no pressure differential is used.

According to M Stanoevic, Review of membrane contactors designs and applications of different modules in industry, FME Transactions (2003) 31, 91-98, a membrane phase, which is set between two bulk phases, has the ability to control mass transfer between the two bulk phases in a membrane process. Contrary to such a membrane, the porous partitioning layer according to the subject invention is set between the two bulk phases, but has in principle no ability to control the mass transfer of any of the species involved. It does therefore essentially not interact with the species to be separated other than offering pores, but merely serves to avoid mixing of the two bulk phases, contrary to membrane separations.

The subject porous partition is thus essentially not a selectively permeable membrane. A membrane is a barrier that allows some compounds to pass through, while effectively hindering other compounds to pass through, thus a semi-permeable barrier of which the pass-through is determined by size or special nature of the compounds. Membranes used in gas separation techniques are for instance those disclosed in U.S. Pat. No. 5,843,209. Membranes selectively control mass transport between the phases or environments.

Contrary to such membranes, the porous partition is a barrier that allows the flow of all components, albeit at different relative rates of diffusion. Without wishing to be bound to any particular theory it is believed that in the porous partitioning, the mass transfer is controlled by frictional diffusion with a sweeping gas component continuously added to one chamber and leaving the other chamber and diffusing counter-currently through the porous partitioning layer.

Preferably the material used for the porous partition is essentially inert or inert to the components used in the separation process. In practice the invention may frequently be carried out whilst using filter cloth, metal, plastics, paper, sandbeds, zeolites, foams, or combinations thereof as material for the porous partition. Examples include expanded metals, e.g. expanded stainless steel, expanded copper, expanded iron; woven metals, e.g. woven copper, woven stainless steel; cotton, wool, linen; porous plastics, e.g. porous PP, PE or PS. In a preferred embodiment the porous partition is prepared from woven or expanded stainless steel.

Preferred porous material should have a high porosity (ε) to maximise the useful surface area. The preferred porous layers porous have a porosity of more than 0.5, preferably more than 0.9, yet more preferably more than 0.93.

The thickness of the porous layer is preferably as low as possible. Without whishing to be bound to any particular theory, it is believed that the diffusive rate is inversely proportional to the thickness of the porous layer, and thus the required surface area of the porous layer is proportional to the thickness.

The porous partition can vary widely in thickness and may for example vary from a partition having a thickness of 1 or more meters to a partition having a thickness of 1 or more nanometres. For practical purposes the invention may frequently be carried out using a porous partition having a thickness in the range from 0.0001 to 1000 millimetres, more preferably in the range from 0.01 to 100 millimetres, and still more preferably in the range from 0.1 to 10 millimetres. Preferred porous layers have a thickness in the range of from 0.5 to 1.5 millimetres, preferably in the range of from 0.8 to 1.2 millimetres, and more preferably in the range of from 0.9 to 1.1 millimetres.

The amount, size and shape of the pores used in the porous partition may vary widely. The shape of the pores used in the porous partition may be any shape known to the skilled person to be suitable for such a purpose. The pores can for example have a cross-section shaped as slits, squares, ovals or circles. Or the cross-section may have an irregular shape. For practical purposes the invention may frequently be carried out using pores having a cross-section in the shape of circles. The diameter of cross-section of the pores may vary widely. It is furthermore not necessary for all the pores to have the same diameter. For practical purposes the invention may frequently be carried out using pores having a cross-section “shortest” diameter in the range from 1 manometer to 10 millimetre. By the “shortest” diameter is understood the shortest distance within the cross-section of the pore. Preferably this diameter lies in the range from 20 nanometre to 2 millimetres, more preferably from 0.1 to 1000 micrometer, more preferably in the range from 10 to 100 micrometer.

Preferably, the pores in the material should be relatively small to prevent convective flow. The exact size and proportions depend on the thickness of the porous layer (Δ) and the pressure drop (ΔP) across the porous layer as well as the physical properties of the gas (viscosity and density).

Pores having a small diameter, e.g. in the range from 0.1 to 100 nanometres have the advantage that the control on pressure differences becomes more easy. Pores having a larger diameter, e.g. in the range from 100 to 1000 nanometres have the advantage that a better separation can be obtained. For instance at a pressure drop (ΔP) of around 10 Pa across the porous partition, the pores should have a diameter below 10 micrometer to prevent substantial convective flow as compared to the desired diffusive flow. At a pressure drop (ΔP) of 1 Pa, pores having a diameter of 30 micron should be preferred. However, pressure drop and pore diameter should be chosen in such way that a Knudsen diffusion regime is avoided.

Is it understood that the relative rates of diffusion through the porous layer of different gases are dependent on the relative magnitudes of their binary diffusion coefficients, and not or only to a lesser extent on the properties of the porous material.

The pores may furthermore vary widely in tortuosity, that is, they may vary widely in degree of crookedness. Preferably however, the pores are straight or essentially straight and have a tortuosity in the range from 1 to 5, more preferably in the range from 1 to 3.

The number of pores used in the porous partition may also vary widely. Preferably 1.0-99.9% of the total area of the porous partition is pore area, more preferably 40 to 99%, and even more preferably 70 to 95% of the total area of the partition is pore area. By pore area is understood the total surface area of the pores. For practical purposes the invention may frequently be carried out using a number of pores and a pore size such that the ratio of total surface area of pores in the partition to the gas volume of the mixture of components lies in the range from 0.01 to 100,000 m²/m³, preferably in the range from 1 to 1000 m²/m³.

The length of the porous partition in the direction of the flow of the stream of sweeping component may also vary widely. When the length of the layer is increased both building costs of the separation as well as the extent of separation increase. For practical purposes the invention may frequently be carried out using a porous partition having a length along the flow-direction of the sweeping component in the range from 0.01 to 500 meters, more preferably in the range from 0.1 to 10 meters.

In the separation apparatus, the first and second chamber can be arranged in several ways. In a preferred embodiment one chamber is formed by the inside space of a tube and the other chamber is formed by a, preferably annular, space surrounding such tube. The present invention further provides a separation unit, suitable for separating a first component from a mixture of components by diffusion of the first component through a porous partition into a stream of sweeping component, which separation unit comprises:

an outer tube;

an inner tube, which inner tube has a porous wall, and which inner tube is arranged within the outer tube, such that a first space is present within the inner tube and a second space is present between the outer surface of the inner tube and the inner surface of the outer tube;

a first inlet for conveying fluid into the first space;

a first outlet for discharging fluid from the first space;

a second inlet for conveying fluid into the second space;

a second outlet for discharging fluid from the second space; and

a pressure equilibrating device connecting and mediating between the first and the second chamber.

In a different preferred embodiment, the first and the second chamber are separated by a porous partition formed by stacks of plates or sheets of the porous material. In these stacks, at least two plates, i.e. an upper plate and a lower plate comprising the porous partition material are layered above each other in such way as to provide an intermediate compartment, which is blocked off at one end, while fluidly connected to an open space at the other end. In stacks comprising more than two layers, the openings on adjacent sides of each intermediate compartment are blocked alternately. Hence, the stack separates a first chamber and a second chamber as set out above, while the chambers are at least in part formed by the stack. The plates of comprising the porous partition material may be at any suitable shape, for instance rectangular; they may be of even shape and size, or uneven. The latter is preferred since then one side of a plate is longer than the other side, and thus the flow of the faster flowing gas passes across the shorter distance, thereby lowering the pressure drop.

The compartments are typically defined by spacers or structures that are offset and support the porous partition. The spacer, along with the porous partition material connected thereto defines the intermediate compartment which may serves as retentate or sweeping compartment. The pressure drop may also conveniently be adjusted by using different spacers for the sweep gas and feed gas compartments.

Adjacent compartments have the porous partition positioned there-between in the shape of layered plate-like or sheet-like structures, thereby providing a flow path for both fluid streams with a large surface. The assembly of retentate and sweeping compartments may be in alternating order or in any of various arrangements necessary to satisfy design and performance requirements. The stack arrangement is typically bordered by a seal at one end and a fluid connection to another compartment at an opposite end.

The compartments are suitably placed into a separator vessel such that they are fluidly connected either to a fluid stream, while they are sealed towards the respective opposite fluid stream, thus separating the two fluid feed streams. The feeds of the two fluid streams are fed preferably in a cross flow arrangement to the alternate sides of the separator vessel, i.e. to arrive at perpendicular flow or cross-flow direction towards each other. This serves to bring the flows out of line (i.e. not co-linear flows) so that they can be fed to the vessels fluid inlet and outlet openings more easily.

The separation device suitable comprises a vessel comprising a first fluid inlet opening positioned proximate to a side of the vessel and a first fluid outlet opening positioned proximate to an opposing side of the vessel; a second fluid inlet opening positioned proximate to a side of the vessel and a second fluid outlet opening positioned proximate to an opposing side of the vessel, wherein the first and second inlets and outlets respectively are position in such way, that the flow direction of a first fluid stream entering the vessel at the first inlet, and leaving it at the first outlet, and a second fluid stream entering the vessel at the second inlet, and leaving it at the second outlet are essentially perpendicular to each other; and wherein the porous partition between the two fluids comprises a stack of plate-like structures which are sealed toward the first fluid stream, while fluidly connected to the second fluid stream, thereby forming an exterior flow space for the first stream defined at least partially by and positioned at least partially between an upper plate and a lower plate of porous material, and an interior flow space for the second stream, defined at least partially by and positioned at least partially between the opposite sides of the upper plate and the lower plate to prevent fluid flow from the exterior flow space into the interior flow space, wherein a pressure equilibrating device connects to and mediates between the first and the second chamber. The advantage of using a stacked separation device is that in cross-flow many parallel compartments are alternately connected to the feed stream and to the sweep gas stream, thus providing for a large surface in a relatively compact arrangement.

The fluids are, each independently, for preferably at least 50% wt in the gaseous state, more preferably at least 80% wt, and even more preferably in the range from 90 to 100% wt. Most preferably the fluids are nearly completely or completely gaseous.

Furthermore the inner tube and the outer tube are preferably arranged essentially co-axially.

The first space can either be used as a first chamber or as a second chamber and the second space can respectively be used as a second chamber or as a first chamber. Both the first as well as the second space can have multiple inlets and outlets. Preferably the first space present within the inner tube has only one inlet and only one outlet. The second space preferably has two or more, preferably 2 to 100 inlets and/or outlets or an inlet and/or outlet in the shape of a circular slit. The inner tube can be arranged substantially eccentrically within the outer tube such that the central axis of the inner tube is arranged substantially parallel to the central axis of the outer tube. Preferably, however the inner tube is arranged substantially concentrically within the outer tube such that the central axis of the inner tube substantially coincides with the central axis of the outer tube. The cross-section of the tubes can have any shape known to the skilled person to be suitable. For example, the tubes can independently of each other have a cross-section in the shape of a square, rectangle, circle or oval. Preferably the cross-section of the tubes is essentially circular.

The present invention also preferably provides a multitubular separation device comprising:

a substantially vertically extending vessel,

a plurality of tubes having a porous wall, arranged in the vessel parallel to its central longitudinal axis of which the upper ends of the tubes are fixed to an upper tube plate and in fluid communication with a top fluid chamber above the upper tube plate and of which the lower ends are fixed to a lower tube plate and in fluid communication with a bottom fluid chamber below the lower tube plate,

supply means for supplying a first fluid to the top fluid chamber,

an effluent outlet arranged in the bottom fluid chamber,

supply means for supplying a second fluid to the space between the upper tube plate, the lower tube plate, the outer surface of the tubes and the vessel wall, and

an effluent outlet from such space between the outer surface of the tubes and the vessel wall, and a pressure equilibrating means situated at any suitable position within the separation unit.

The separation units according to the subject invention can be arranged in the separation device in any manner known to suitable for this purpose by the skilled person. Preferably the separation units are arranged sequentially or parallel to each other in the separation device. The separation units can for example be sequentially arranged in an array. If such an array of sequentially arranged separation units is used, any pressure loss on either one side is preferably compensated by a intermediate stream of respectively mixture of components or sweeping component.

The subject invention also provides for a separation process comprising a gas separation process wherein a first component is separated from a feed stream comprising a mixture of components by diffusion of the first component through a porous partition into a stream of sweeping component, wherein the pressure at both sides of the porous partition is maintained continuously at essentially equal levels by equilibrating the pressure of the fluid streams.

By a gas separation process is understood that during this separation process at least part of the first component, mixture of components and sweeping component is in the gaseous state during the separation process. Preferably at least 50% wt of the first component, mixture of components and sweeping component is in the gaseous state, more preferably at least 80% wt, and even more preferably in the range from 90 to 100% wt is in the gaseous state. Most preferably all components are completely in a gaseous state during the separation process. A component which is normally in the liquid state under ambient temperature (25° C.) and pressure (1 bar) can be vaporized to the gaseous state, for example by increasing temperature or lowering pressure, before diffusing through the porous partition. The diffusion during the gas separation process is hence preferably gas diffusion.

Without wishing to be bound by any kind of theory, the diffusion of the first component through the porous partition during the separation process is thought to be based on the so-called principle of frictional diffusion. This frictional diffusion is believed to be due to a difference in the rate of diffusion of a one component compared to one or more other components. As explained also in U.S. Pat. No. 1,496,757, a component having a faster rate of diffusion will more quickly pass a porous partition than a component having a slower rate of diffusion. The quicker component can be removed by the stream of sweeping component, resulting in a separation of such a first, quicker component from the remaining components. In the above a quicker component is understood to be a component having a higher binary diffusion coefficient together with the sweeping component than a slower component.

By a sweeping component is understood a component which is able to sweep away a first component that has diffused through the porous partition. It can be any component known to the skilled person to be suitable for this purpose. Preferably a component is used which is at least partly gaseous at the temperature and pressure at which the separation process is carried out. More preferably a sweeping component is used which is nearly completely, and preferably completely gaseous at the temperature and pressure at which the separation process is carried out. For practical purposes the invention may frequently be carried whilst using a sweeping component having a boiling point at atmospheric pressure (1 bar) in the range from −200 to 500° C. More preferably a sweeping component is used sweeping component having a boiling point at atmospheric pressure (1 bar) in the range from −200 to 200° C. Examples of components that can be used as sweeping component include carbon monoxide, carbon dioxide, hydrogen, water, oxygen, oxides, nitrogen-containing compounds, alkanes, alkenes, alkanols, aromatics, ketones.

The mixture and the sweeping component are separated by a porous partition, through which the first component diffuses from the mixture into the stream of sweeping component. The residence time of the sweeping component and/or the mixture of components in the separation unit can vary widely. For practical purposes the invention may frequently be carried out using a residence time for sweeping component and/or the mixture of components in the separation unit in the range from 1 minute to 5 hour. Preferably a residence time is used in the range from 0.5 to 1.5 hours.

The velocity of the sweeping component used in the process of the invention may vary widely. For practical purposes the invention may frequently be carried out at a velocity of the sweeping component in the range from 1 to 10,000 meters/hour, preferably in the range from 3 to 3000 meters/hour and more preferably in the range from 10 to 1000 meters/hour. If not stationary, similar velocities can be used for the mixture of components.

The flux of the diffusion of the first component through the porous partition can vary widely. For practical purposes the invention may frequently be carried out at a diffusion flux of the first component through the porous partition in the range from 0.03 to 30 kg/m²/hour, preferably in the range from 0.1 to 10 kg/m²/hour and more preferably in the range from 0.5 to 1.5 kg/m²/hr.

For practical purposes the invention may frequently be carried out by removing from 10 to 100% wt of the first component, based on the total amount of first component present in the mixture of components when starting the separation process, from the mixture of components. More preferably at least 30% wt, and more preferably at least 50% wt of first component present in the mixture is removed from the mixture of components during the separation process. Even more preferably in the range from 70 to 100% wt of first component, based on the total amount of first component present in the mixture of components when starting the separation process, is removed from the mixture of components during the separation process. Especially when removing a high percentage, e.g. in the range from 70 to 100% wt, of first component from the mixture of components, other components might also diffuse from the mixture of components into the stream of sweeping component. When such other components co-diffuse, they can be removed in an additional intermediate step before entering the preparation process; or, alternatively, such other co-diffused components can remain in admixture with the sweeping component and/or with the diffused first component during a subsequent preparation process. Possibly such other co-diffused components can be removed via a bleed stream in such a subsequent preparation process.

The first component can be separated from a stationary mixture by diffusion through a porous partition into a stream of sweeping component. Preferably, however, a separation process is used, wherein the first component is separated from a stream of a mixture of components on one side of a porous partition, by diffusion through such porous partition, into a stream of sweeping component on the on the opposite side of the porous partition. Such a separation process might be carried out co-currently, counter-currently or cross-currently. Preferably, however, such a separation process is carried out whilst having a stream of the mixture of components and a stream of sweeping component flowing counter-currently in respect of each other. The separation process can be carried out continuously, semi-batch or batch-wise. Preferably the separation process is carried out continuously.

The flow velocity of the stream of sweeping component can vary widely. For practical purposes the invention may frequently be carried out using a flow velocity for the stream of sweeping component in the range from 0.01 to 300 kmol/hour, more preferably in the range from 0.1 to 100 kmol/hour. The flow velocity of any flow of mixture of components (if not stationary) can also vary widely. For practical purposes the invention may frequently be carried out using a flow velocity for the stream of sweeping component in the range from 0.01 to 300 kmol/hour, more preferably in the range from 0.1 to 100 kmol/hour.

The temperature applied during the separation process can vary widely. Preferably such a temperature is chosen that all components are completely gaseous during the diffusion process. More preferably the temperature in the separation process is the same to the temperature in the preparation process. For practical purposes the invention may frequently be carried out using a temperature in the range from 0 to 500° C., preferably in the range from 0 to 250° C. and more preferably in the range from 15 to 200° C.

The pressures applied may vary widely. Preferably such a pressure is chosen that all components are completely gaseous during the diffusion process. More preferably the pressure in the separation process is the same to the pressure in the preparation process. For practical purposes the invention may frequently be carried out using a pressure in the range from 0.01 to 200 bar (1×10³ to 200×10⁵ Pa), preferably in the range 0.1 to 50 bar. For example the separation process can be carried out at atmospheric (1 atm., i.e. 1.01325 bar) pressure.

Independently from the overall pressures applied, the pressure difference over the porous partition is maintained as small as possible, e.g. in the range of 0.0001 to 0.1 bar, provided that separation by diffusion prevails over any separation due to mass motion because of large pressure differences. The pressure difference preferably is in the range of from 0.0001 to 0.01 bar, more preferably in the range of 0.0001 to 0.001 bar, yet more preferably in the range 0.0001 to 0.0001 bar, and most preferably in the range of from 0.0001 to 0.0005 bar. Hence, the pressure on both sides of the porous partition is considered nearly equal or essentially equal.

In a further preferred embodiment the separation process is carried out in a separation device comprising a multiple of separation units, preferably in the range from 2 to 100,000, more preferably in the range from 100 to 10,000 separation units per separation device.

The fluids are, each independently, for preferably at least 50% wt in the gaseous state, more preferably at least 80% wt, and even more preferably in the range from 90 to 100% wt. Most preferably the fluids are nearly completely or completely gaseous.

A mixture of components can for example be supplied to the space inside the tubes or to the space between the outer surface of the tubes and the inner surface of the vessel wall; and the sweeping gas can be supplied to respectively the space between the outer surface of the tubes and the inner surface of the vessel wall or the space inside the tubes.

1. A gas separation apparatus comprising:
a first chamber;
a second chamber, separated from the first chamber by a porous partition;
a first inlet for conveying a mixture of components to the first chamber;
a first outlet for discharging the remainder of the mixture of components after at least part of the first component has been removed from the first chamber;
a second inlet for conveying a sweeping component into the second chamber;
a second outlet for discharging a mixture of sweeping component and diffused first component from the second chamber; and
a pressure equilibrating device connecting and mediating between the first and the second chamber, wherein the pressure equilibrating device comprises a diaphragm.

2. An apparatus of claim 1, wherein the porous partition is a porous partition suitable for a separation by frictional diffusion.

3. The apparatus of claim 1, wherein the pressure equilibrating device is part of a valve chamber in which the first and second chamber of the apparatus of the invention that are associated with the two outlet conduits are situated.

4. The apparatus of claim 1, wherein the first and second chamber comprise the pressure equilibrating device within the chambers.

5. The apparatus of claim 1, wherein the pressure equilibrating device is incorporated into the porous partition.

6. The apparatus of claim 1, wherein the pressure equilibrating device is a self-directing pressure and flow regulating device.

7. The apparatus of claim 1, comprising:
an outer tube;
an inner tube, which inner tube has a porous wall, and which inner tube is arranged within the outer tube, such that a first space is present within the inner tube and a second space is present between the outer surface of the inner tube and the inner surface of the outer tube;
a first inlet for conveying fluid into the first space;
a first outlet for discharging fluid from the first space;
a second inlet for conveying fluid into the second space; and
a second outlet for discharging fluid from the second space.

8. A multitubular separation device comprising:
a substantially vertically extending vessel,
a plurality of tubes having a porous wall, arranged in the vessel parallel to its central longitudinal axis of which the upper ends of the tubes are fixed to an upper tube plate and in fluid communication with a top fluid chamber above the upper tube plate and of which the lower ends are fixed to a lower tube plate and in fluid communication with a bottom fluid chamber below the lower tube plate,
supply means for supplying a first fluid to the top fluid chamber,
an effluent outlet arranged in the bottom fluid chamber,
supply means for supplying a second fluid to the space between the upper tube plate, the lower tube plate, the outer surface of the tubes and the vessel wall,
an effluent outlet from such space between the outer surface of the tubes and the vessel wall, and
a pressure equilibrating means situated at any suitable position within the separation unit, wherein the pressure equilibrating device comprises a diaphragm.

9. A separation process comprising a gas separation process wherein a first component is separated from a feed stream comprising a mixture of components by diffusion of the first component through a porous partition into a stream of sweeping component, wherein the pressure at both sides of the porous partition is maintained continuously at essentially equal level by equilibrating the pressure of the fluid streams by means of a pressure equilibrating device, wherein the pressure equilibrating device comprises a diaphragm.
